(19) United States
(12) Patent Application Publication
(10) Pub. No.: US 2018/0011477 A1
(43) Pub. Date: Jan. 11, 2018

(54) METHOD AND SYSTEM FOR PACKAGING A PRODUCT

(71) Applicant: CIRTES, Saint Die Des Vosges (FR)

(72) Inventors: Claude BARLIER, Coinches (FR); Rizad DEBBOUB, Weisenbach (FR)

(21) Appl. No.: 15/694,939

(22) Filed: Sep. 4, 2017

Related U.S. Application Data
(63) Continuation-in-part of application No. 12/530,220, filed on Sep. 7, 2009.

(51) Int. Cl. G05B 19/4099; B65D 81/05; B65D 75/38

(52) U.S. Cl. CPC G05B 19/4099; B65D 75/38; B65D 81/05

(57) ABSTRACT

The invention relates to a method and packing system for producing a package for a product to protect the product, during transportation or storage. The method includes digitizing the product so as to form a virtual key form and determining geometric data. The virtual key form is laminated according geometric data in order to form stratoconception layers. Then, the sheet material is cut into packaging layers corresponding the stratoconception layers, and the packaging layers are stacked to form a package for the more stable protection of the product. The packing system includes the product, package and shipping container.

### CROSS-REFERENCE TO RELATED APPLICATIONS

The present application claims continuation-in-part priority under 35 U.S.C. §120 from U.S. Ser. No. 12/530,220, filed on 7 Sep. 2009, and entitled “PACKAGE DESIGN METHOD USING STRATODESIGN INTEGRATED IN THE METHOD FOR DESIGNING THE PRODUCT TO BE PACKAGED”.

See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a method and packing system for packaging a product.

### 2. Description of Related Art Including Information Disclosed Under 37 CFR 1.97 and 37 CFR 1.98

French Patent No. 2 717 734 (the French '734 patent), granted to Lepaul et al on 14 Jun. 1996 relates to a machining technique that works by eliminating an external volume of an object. The French '734 patent produces three dimensional models from computer aided design (CAD) files. There is no disclosure of the application in packing system, and the particular limitations and requirements for protection of the product are not disclosed.

Other prior art references have linked computerized modeling to manufacture of packaging, including U.S. Pat. No. 7,031,788 (the '788 patent), issued to Shenefelt et al on 18 Apr. 2006, and U.S. Patent Publication No. 20040220692 (the '692 publication), published on 4 Nov. 2004 for Shenefelt et al. The '788 patent and the '692 publication propose two dimensional outlines of a product to determine the shapes in layers of a package. Multiple layers can be arranged and aligned so that a product fits into the multiple layers for a stable and protective package to be transported. The '788 patent and the '692 publication rely on known imaging of the product or products to create the outlines, which are then incorporated into the layers.

The multiple layers of the '788 patent and the '692 publication inherently have length, width, and height dimensions as three-dimensional objects. All layers inherently have length, width, and height or thickness. Although the imaging of the prior art determines the length and width, there is no disclosure related to the selection of height or thickness of the layer. These prior art methods may be sufficient for simple tools, when the product can be protected without regard to thickness. For some objects, such as a hammer, there is no rotation within the shape or cavity defined by the layers. The head of the hammer prevents rotation along the axis of the handle of the hammer, so there is no movement of the hammer within the shape or cavity of layers, and the layers effectively restrict movement for protection the hammer. Any layer or multiple layers of any thickness are sufficient to support and maintain these types of objects.

Products with high added value, such as in the automobile, aeronautical, medical, art, glassware and other such sectors, require improved protection. These products may have hollow portions or rotatable portions that could be damaged in packaging of the prior art. There is a need for improved packaging of multiple layers to account for products with these rotatable and hollow portions.

“Stratoconception” is a term introduced in European Patent No. 0585502 (the '502 EP), granted to Barlier on 9 Mar. 1994. The '502 EP discloses a method for creation and realization of parts with computer aided design (CAD) files. In this method, a product is scanned by three dimensional imaging into a CAD file as the virtual product or a product is created as a CAD file as the virtual product. The method decomposes the virtual product into elementary layers based on the structural stresses and manufacturing process. With the hammer as the example, the elementary layers for the handle of the hammer would be nearly identical; the elementary layers for the head would also be nearly identical; and the elementary layers at the transition from handle to head would be identified. Each elementary layer would have a length, width, and height for the construction of the product by material layers corresponding to the elementary layers. Assembly of the material layers would form the product in real life.

The stratoconception method selects the length, width, and height of the elementary layers based on the geometric data of the hammer, such as handle length, head width, etc. and the structural stress, such as the transition from handle to head. The material layers for the handle must span a particular length to form the handle, so the number of material layers could be as simple as one, if the material layer can be thickness enough for the entire handle to the transition to the head. One material layer with a thickness (28.5 cm) of the handle length is possible. However, if the machining of the manufacturing process is limited in range of 0-1.0 cm, then the method may select 28 elementary layers of 1.0 cm thickness and 1 elementary layer of 0.5 cm thickness so that the material layers are possible and efficient for construction. The geometric data and the structural stresses form the elementary layers for the construction of a product by assembly of material layers.

It is an objective of the invention to propose a method for constructing a package by total integration of the method in the product's digital design system in order to effectively meet the cost and lead time constraints by eliminating the production of costly toolage.

These and other objects and advantages of the present invention will become apparent from a reading of the attached specification and appended claims.

### BRIEF SUMMARY OF THE INVENTION

Embodiments of the present invention incorporate stratoconception into constructing the package of the product, instead of the product itself. The package has different requirements, since the package is only functioning to support and protect the product. For example, the present invention is a method of packaging a hammer, not a method of assembling the hammer itself. As such, the present invention discloses a particular modification of the methods used for manufacture products in order to manufacture packaging.

The method for packaging product includes digitizing a product so as to form a virtual key form, determining geometric data of the virtual key form, and laminating the virtual key form based on geometric data into stratoconception layers. Then, sheet material layers are cut, according to each stratoconception layer. The sheet material layers are stacked to form the package. The product can now be placed in the package for protection during transport or storage.

The geometric data can be comprised of three dimensional contours corresponding to a surface of the product, and the stratoconception layers can be based on ability to rotate and interior volume. Each stratoconception layer has a respective three dimensional contour corresponding to a portion of the surface of the product aligned with the respective stratoconception layer.

Embodiments of the present invention include numbering the sheet material layers for assembling the package and the packing system resulting from the method of the present invention. The packing system includes the product, the package according to the method, and the shipping container. Various accessories for additional support and organization can be included in the packing system.

### BRIEF DESCRIPTION OF THE SEVERAL VIEWS OF THE DRAWINGS

FIG. 1 is a perspective view of a first digitized product, according to an embodiment of the present invention.

FIG. 2 is an exploded perspective view of the first digitized product and virtual key form, according to FIG. 1.

FIG. 3 is a top plan view of the stratoconception layers of embodiments of the present invention for the first digitized product of FIG. 1.

FIG. 4 is a perspective view of the stratoconception layers being stacked in order, according to embodiments of the present invention.

FIGS. 5 and 6 are perspective views of the sheet material layers, according to FIG. 1, stacked from the bottom in FIG. 5 and stacked from the top in FIG. 6.

FIG. 7 is a perspective view of second digitized product, according to embodiments of the present invention.

FIG. 8 is an exploded perspective view of the second digitized product and virtual key form, according to FIG. 7.

FIG. 9 is a perspective view of the stratoconception layers of embodiments of the present invention for the second digitized product of FIG. 7.

FIG. 10 is a perspective view of sheet material layers, according to FIG. 7.

FIG. 11 is a perspective view of a shipping container, according to embodiments of the present invention.

FIG. 12 is an exploded perspective view of a packing system, according to embodiments of the present invention.

FIG. 13 is a perspective view of a prior art conventional package.

FIGS. 14A, B, C, and D are schematic views of the prior art layers (FIGS. 14A and 14B) and the stratoconception layers (FIGS. 14C and 14D) of the present invention.

### DETAILED DESCRIPTION OF THE INVENTION

The present invention is a method for producing a package for the protection and/or transportation of a product. The steps for forming the package are integrated into a method with digitization of the product, which includes a step of laminating a virtual key form of the product from the digital definition of the product. The step of laminating defines dimensions of each layer of actual sheet material to be cut for the package. Then, the cutting is carried out for sheet material layers followed by the stacking of the sheet material layers to form a real package.

The package according to the invention can be formed at the same time as the product itself, such as being formed from the initial computer aided design (CAD) file. Alternatively, the package can be formed after digitization of the physically produced product, such as retro-design by scanning the product.

This method uses the digital definition of the product (such as a digital scan obtained by digitization or by digital profile created in CAD) to digitally produce, using automatic software, the laminated stratoconception of the package. This package is then produced from sheets of selected material and using an appropriate cutting means.

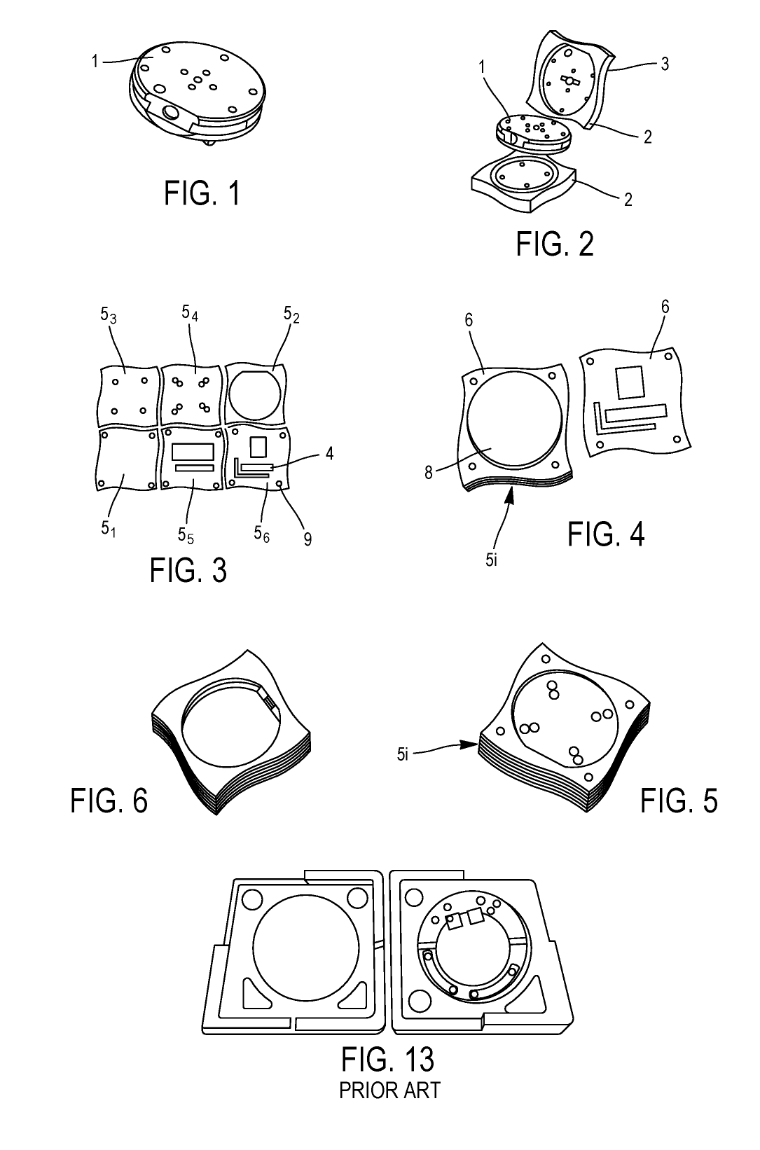

FIGS. 1-6 show an embodiment of a first virtual model 1 of the product to be packaged. The first virtual model 1 is digitized as a result of a scan of an actual product or the CAD file of a product to be created. The virtual key form 2 is formed based on the digitized product, so that geometric data of the virtual key form 2 can be determined. In particular, the three dimensional contours corresponding to the surface of the product are determined for the virtual key form 2. The complete surface area of the product from all orientations corresponds to the surface of the virtual key form 2 for a perfect enveloping fit of the virtual key form 2 to the product.

The method includes laminating the virtual key form 2 into stratoconception layers 3. The geometric data defines stratoconception layers based on length, width, thickness (height), contour, rotation, hollow portions, manufacturing process, additional placements 4, and arrangement of those additional placements. The additional placements 4 may fit accessories, preservation products, such as dehumidifying agents, detection elements, and identifications to be packaged with the product.

Stratoconception layers 3 are layers with an inherent length, width, and thickness as any layer. However, the stratoconception layers 3 are not purely based on geometric data, as in the prior art. Just as stratoconception in the product manufacture relied on geometric data and structural stress and the manufacturing process, stratoconception for package manufacture relies on more than geometric data. It is necessary to determine a stratoconception layer 3 with the additional determinations for safe and more stable protection of the product.

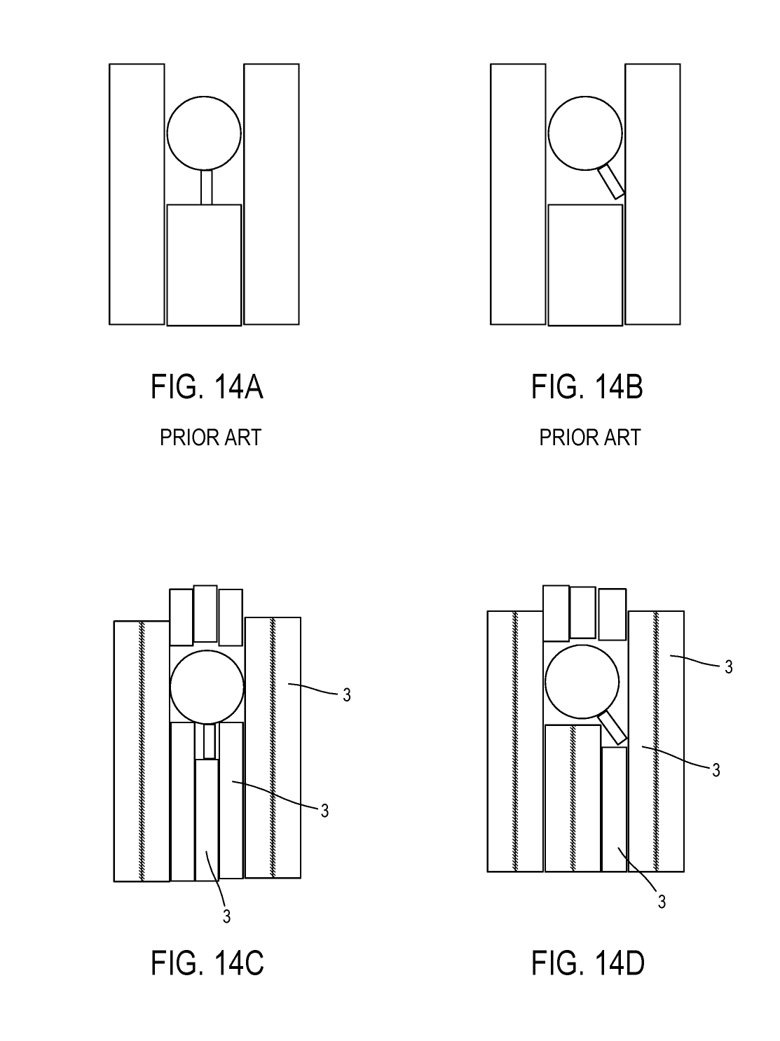

FIGS. 14A and 14B show schematic views of the layers of the prior art. The use of geometric data alone results in the problem shown in FIG. 14B. When the product has an axis of rotation, the reliance on geometric data is not sufficient to address the protection of the product. A product, such as a ball point pen or a high end thermometer, would not be stabilized. The layers have an arbitrary thickness, which may or may not address the complete surface area and the relevance of the complete surface area.

FIGS. 14C and 14D show schematic views of the stratoconception layers 3 of the present invention. The stratoconception layers 3 also have length, width, and thickness individually. However, each length, width, and thickness is determined by geometric data in addition to contour, rotation, hollow portions, manufacturing process, and additional placements 4. The orientation of the product in FIG. 14C is possible with the method of the present invention, and the orientation of the product matches the orientation in FIG. 14A of the prior art. However, the stratoconception layers 3 are different because the stratoconception layers 3 account for the geometric data and preventing rotation. FIG. 14B shows a further example of stratoconception layers 3 with consideration of the hollow portions. The preferred orientation of the product may be the orientation of FIG. 14D, such as a sensitive thermometer requiring fluid in a hollow interior to remain in a reservoir on one side of the thermometer. The stratoconception layers 3 account for this different orientation and the stable maintenance of this orientation. Although the prior art of FIG. 14B can reach the same orientation, there is no stabilization or support of the orientation, such that the product would freely rotate, upsetting the fluid in the thermometer.

Additionally, the manufacturing process may further determine the stratoconception layers 3. FIGS. 14C and 14D show the standardization of the layer thickness for easier machining of a uniform sheet material. The geometric data itself cannot lead to these stratoconception layers 3. The limitations of the manufacturing process are common considerations, but the additional modification is the consideration of limitations of the manufacturing process in view of the stratoconception, i.e. geometric data in addition to contour, rotation, hollow portions, manufacturing process, and additional placements 4.

Embodiments of the method of the present invention further include the step of cutting sheet material into sheet material layers 5. The sheet material layer 5 corresponds to a stratoconception layer 3. The sheet material layer 5 is the physical manifestation of the digital stratoconception layer 3. The material selected for the sheet material includes cardboard or other recyclable material, for example a natural-fiber-based material. It is of course possible to use a non-recyclable material in a sheet form, such as sheet polystyrene. Furthermore, the step of cutting the sheet material can be concurrent with the manufacture of the product. Since the stratoconception layers 3 are digital based on the virtual key form 2, the sheet material layers 5 can be formed before, during, or after the actual product is formed.

The next step is stacking the sheet material layers 5 to form a package 6. FIGS. 3-6 show the package 6 formed by stacking the sheet material layers 5i in FIGS. 4-5 and individual sheet material layers 5₁, 5₂, 5₃, 5₄, 5₅, and 5₆ in FIG. 3. The product 8 in FIG. 4 can be placed in the package 6, which can be further placed inside a packing system, such as a shipping container or box (reference numeral 7 in FIG. 11 as an example). The product 8 is shown as a mechanical casing 8.

FIGS. 1-6 present a first embodiment of the method and system of the present amendment with the product having a mechanical casing 8. FIG. 3 represents six different shapes of sheet material layers 5 as cardboard layers. After stacking and snap fitting to each other at stamping 9, the package 6 can be assembled. The sheet material layers 5 can also be positioned relative to each other by holes of the stamping 9 into which positioning and fixing inserts can be inserted. In this case, the sheet material layers 5 can be self-supporting. The sheet material layers 5 can also be held by the outer packing, which is then used to position and to hold the stack of sheet material layers 5.

FIGS. 3-4 further show that certain sheet material layers 5₁ may be solid, while other sheet material layers 5₂ may have different dimensions, including a main cut to accommodate the mechanical casing 8 of a product. Other sheet material layers 5₃, 5₄ may include drill holes for the positioning of spindles, while other sheet material layers 5₅, and 5₆ are shown with additional placements 4 for holding accessories.

In some embodiments, the method includes numbering each stratoconception layer 3 so that each stratoconception layer 3 is a numbered layer in a sequence. The step of stacking will further include supplying each sheet material layer according to a corresponding numbered layer, so each sheet material layer becomes a numbered sheet material layer. Then the numbered sheet material layers are assembled into the package 6 according to the sequence. The sequence can be displayed on a screen or printed on paper for instructions to assemble the package 6. The sequence includes the relative order according to which the numbered sheet material layers must be stacked so that the product can be positioned in the package 6.

As the figures show, the outer contours of the sheet material layers 5i are not necessarily straight or polygonal. The package 6 advantageously replaces a package of the prior art (see FIG. 13) produced from injection-molded polystyrene, which requires costly toolage and makes the package difficult to recycle.

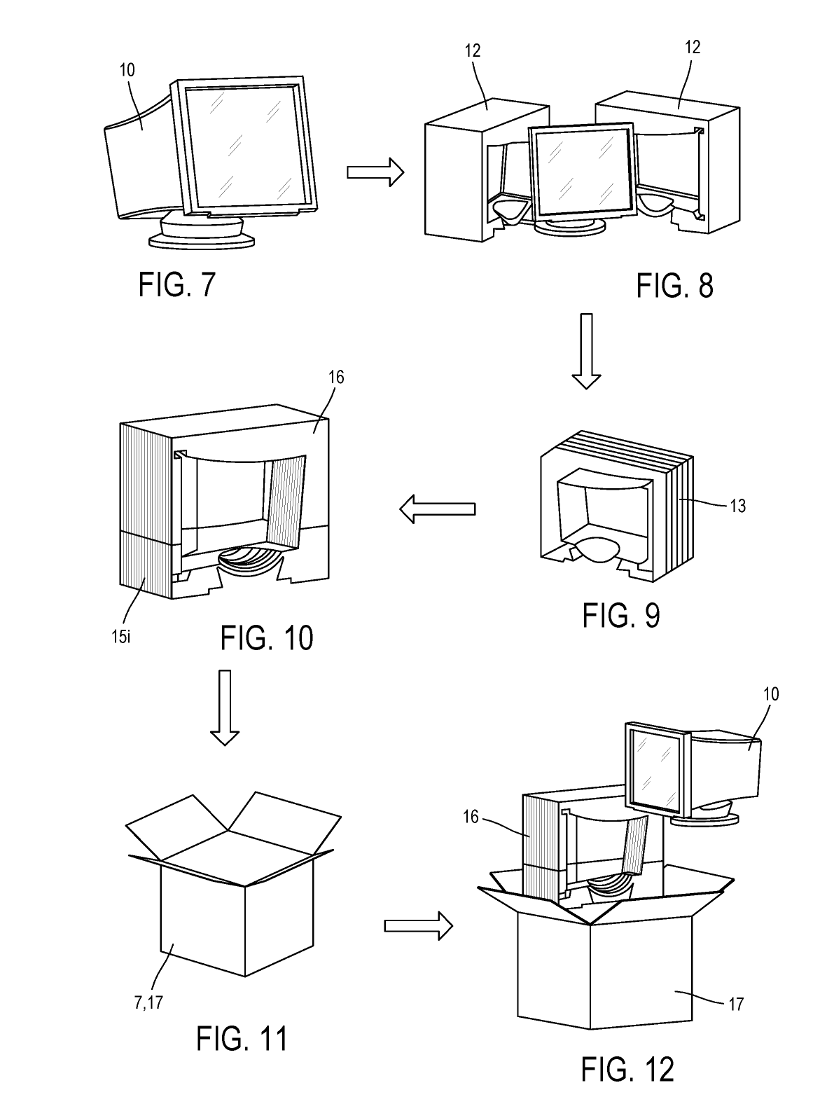

FIGS. 7-12 show the method for a different product, a computer screen. The product 10 is shown in FIG. 7 as computer screen, and the virtual key form 12 based on digitizing the product 10 or based on a CAD file of the product 10, is shown in FIG. 8. FIG. 9 shows the stratoconception layers 13. The sheet material layers 15i of FIG. 10 are stacked into the package 16. The package 16 is shown with a cavity in which the product 10 can be housed and immobilized. Since the outer shape of the sheet material layers 15i is rectangular, the final package 16 is parallelepipedal and can be housed with the product 10 in a shipping container or box 17. The package 16 and box 17 can be determined at the same time as the virtual key form 12 and the stratoconception layers 13 by lamination. The box 17 can be selected from existing stored standard models.

The following comparative table reveals the main benefits of the method and of the product according to the invention.

| | Conventional package | |
|---|---|---|
| Criteria | (Example in FIG. 13 | Inventive package |
| Production | Product packaged in series | Product custom-packaged |
| capacity | production | to order |
| Recycling | Difficult because of the | 100% recycled |
| | polystyrene, 40% recycled | |
| Client type | Retail industry | Manufacturers of parts with |
| | | high added value |
| Reactivity | Low (high costs and lead | High (no toolage design) |
| | times) | |
| Flexibility | Lacks flexibility because of | Very great flexibility, No |
| | the production time, costs, | toolage design, Flexibility |
| | and studies (toolage, | of the digital line |
| | design office, etc.) | |

The benefits of the stratoconception layers also include:
taking into account the dimensions of existing containers and boxes for the packing system;
compatibility with existing products without CAD files;
identifying the stratoconception layers to facilitate assembly;
considering limitations of manufacturing processes, such as rapid micromilling, 5-axes laser, water jet, and hot wire cutting, dimensions of the sheet material layers being selected to offer the benefit of being very close to the exact shape of the product;
selecting the material composition of the sheet material layers to encompass the product as precisely as possible; and
direct and automatic production of the package for the product simply from the digital definition of the product.

Embodiments of the present invention include the packing assembly of FIG. 12 for transportation. The package 16 is formed according to the method, and the product 12 is enclosed within each sheet material layers of the package 16. The number of sheet material layers corresponds to a number of stratoconception layers. The shipping container 17 houses the package 16 with the product 10 within each sheet material layer. The sheet material layers can be recyclable. There can also be a positioning means between adjacent sheet material layers, such as the stamping 9 as snaps or spacers. There can also be a plurality of additional placements 4 or recesses in at least one sheet material layer so as to receive accessories within each recess.

The foregoing disclosure and description of the invention is illustrative and explanatory thereof. Various changes in the details of the illustrated construction can be made without departing from the true spirit of the invention.

We claim:

1. A method for packaging a product, said method comprising:
digitizing a product so as to form a virtual key form;
determining geometric data of said virtual key form, said geometric data being comprised of three dimensional contours corresponding to a surface of the product, said surface being defined by a complete surface area of the product;
laminating said virtual key form based on geometric data into stratoconception layers, each stratoconception layer having a respective three dimensional contour corresponding to a portion of said surface of the product aligned with the respective stratoconception layer;
cutting sheet material corresponding to each stratoconception layer so as to form a respective sheet material layer; and
stacking each sheet material layer so as to form a package.

2. The method for packaging, according to claim 2, further comprising the step of: numbering each stratoconception layer so as to form a numbered layer in a sequence for each stratoconception layer,
wherein the step of stacking further comprises the step of:
supplying each sheet material layer according to a corresponding numbered layer so as to form each numbered sheet material layer;
assembling each numbered sheet material layer according to said sequence.

3. A packing assembly for transportation, comprising:
a package formed according to the method of claim 1;
a product having a surface, said surface being defined by a complete surface area of the product,
wherein said product is enclosed within each sheet material layers, and
wherein a number of sheet material layers corresponds to a number of stratoconception layers; and
a shipping container, said package with said product within each sheet material layer being housed in said shipping container.

4. The packing assembly, according to claim 3, each sheet material layer being comprised of recyclable material.

5. The packing assembly, according to claim 3, further comprising:
a positioning means between adjacent sheet material layers.

6. The packing assembly, according to claim 3, further comprising:
a plurality of recesses in at least one sheet material layer so as to receive accessories within each recess.
